(19) United States
(12) Patent Application Publication
(10) Pub. No.: US 2009/0025248 A1
(43) Pub. Date: Jan. 29, 2009

(54) Food Dehydrator

(76) Inventor: Andris Lannon, West Sacramento, CA (US)

Correspondence Address: BULLIVANT HOUSER BAILEY PC, 1415 L STREET, SUITE 1000, SACRAMENTO, CA, 95814, US

(21) Appl. No.: 11/828,279

(22) Filed: Jul. 25, 2007

(51) Int. Cl. F26B 11/22; F26B 11/00; B65D 69/00; F26B 3/02

(52) U.S. Cl. 34/196; 34/195; 206/223; 34/487

(57) ABSTRACT

A food dehydrator apparatus comprising a plurality of modular food trays, each tray comprising a generally horizontal drying rack having an upper and lower surface and openings providing for air passage extending generally vertically through the tray, a wall located at the periphery of the tray, the wall extending generally vertically at the periphery, and having a top and bottom edge, and an inner and outer wall surface, and a plurality of legs extending from the lower surface of the tray and below the lower edge of the wall, where the trays are stackable, whereby when a first tray is adjacent a second tray, the top edge of the wall of the first tray and the bottom edge of the wall of the second tray form a close fit preventing air passage therebetween, and where when the first modular food tray is position with the legs set on a substantially flat support surface, a gap is formed between the wall bottom edge and the support surface.

### BACKGROUND OF THE INVENTION

1. Field of the Invention

This invention describes a modular food dehydrator adapted for use with a conventional room fan.

2. Description of Related Art

The preservation of foodstuffs by dehydration is well known in the art. The simplest and oldest forms of food dehydration involves stakes, linesm, platforms and the like, where food is exposed to the sun and the air. In some cases, heat is applied to speed the drying process, such as by staking food alongside an open fire.

Many mechanical devices have been developed in modern times, for both commercial and large scale dehydration, and also for home use. Most such devices provide a shelf with openings to allow for air circulation around the food, and means for moving air through and around food that has been placed on the shelf. In many home dehydrator devices, the dehydrator incorporates a motor driven fan to push air through the openings and generally circulate air about the food in the dehydrator. A heater is also typically provided for heating the air before it is circulated by the fan. Such a device is disclosed in U.S. Pat. No. 5,458,050.

U.S. Pat. No. 4,536,643, teaches a cylindrical food dehydrator that includes a base member, a plurality of stackable trays, and a top. The base member has a first chamber adapted to receive a heater element for convection air distribution and a second chamber adapted for a heating element for forced air distribution. The device is thereby convertible between a convection heating made and a forced air heating made.

U.S. Pat. No. 5,878,508, describes a modular food dehydrator utilizing a combination heater and blower assembly that is located on a top surface of a dehydrator modular food tray. The heater and blower assembly includes a motor driven fan, a heating element and an air distribution portion for directing heated air across the support surfaces. This dehydrator modular food tray also includes outlet vents on an outer perimeter surface for exhausting the heated air. In such a device, the air is both warmest and driest at the first tray, and becomes progressively cooler and more humid as it reaches lower trays. Therefore, the food on the trays closest to the hot air source get very dry, while that furthest from the source dries more slowly. U.S. Pat. No. 6,085,442, discloses a similar modular food dehydrator utilizing a heater and blower assembly located on a top surface of a dehydrator.

These prior devices have numerous electrical and moving parts, and are often complicated to use, and to achieve even drying of the food. Locating the heating element and blower motor in the base of a unit also creates cleaning problems. Bases are typically not dishwasher safe. Additionally, the base can become contaminated with drippings that fall through the perforations in the trays, creating a potential health hazard. If meat products are dried, the grease drippings may create a fire.

A blower component is also the most likely component to fail, and as the greatest cost component, it is often the case that it is easier to replace an entire dehydrator unit than attempt to repair. This is particularly so with the many food dehydrators that produce heated air by use of a heating element. For this reason, present dehydrators are expensive and prone to failure, or costly repair and/or replacement.

None of the prior approaches have been able to provide a simple and powerful dehydrator that can be adapted for use with a simple house fan.

### SUMMARY OF THE INVENTION

This invention provides a food dehydrator apparatus comprising a plurality of modular food trays, each modular food tray comprising a generally horizontal drying rack having an upper and lower surface, openings providing for air passage extending generally vertically through the trays, and a wall located at the periphery of the support structure. The wall extends generally vertically at the periphery, and has a top and bottom edge, and an inner and outer wall surface. The apparatus also has a plurality of legs extending from the lower surface of the drying rackand beyond the lower edge of the wall, where the modular food trays are stackable, whereby when a first modular food tray is adjacent a second modular food tray, the top edged of the wall of the first modular food tray and the bottom edge of the wall of the second modular food tray form a close fit preventing air passage therebetween, and when the first modular food tray is set on a substantially flat support surface with the legs set on the support surface, a gap is formed between the wall bottom edge and the support surface.

In one preferred embodiment, the apparatus has a drying rackthat comprises intersecting support elements forming open and closed spaces therein. In a further preferred embodiment, the intersecting support elements comprise two sets of elongated and parallel structures intersecting at right angles.

In a still further preferred embodiment, the support elements have a diamond configuration in cross section. Alternatively, the support elements may comprise intermittent raised portions along their upper surface.

In a different embodiment, the intersecting support elements comprise respective radial and circular sets of structures, preferably where the radial support elements are biased to direct air flow circularly through an assembled apparatus.

The top wall edge is preferably sized to accomodate the outer dimensions of a standard household fan.

In another preferred embodiment, a central support leg extends from the lower surface of the support structure.

The invention also contemplates a food dehydrator kit comprising a fan and a plurality of the described modular food trays. In a preferred such embodiment, the fan is a household fan. Preferred household fans come in dimensions of twenty inches square and ten inches square.

The invention further provides a method for dehydrating food comprising assembling a food dehydrator apparatus and either before, during or after the assembly, placing food onto the upper surface of at least one modular food tray support structure, and circulating room temperature air through the apparatus be actuating the fan.

These and other features and advantages of this invention are described in, or are apparent from, the following detailed description of various exemplary embodiments of the apparatus and methods according to this invention.

### BRIEF DESCRIPTION OF THE DRAWINGS

FIG. 1 shows a perspective drawing showing the modular tray.

FIG. 2 is a different perspective drawing showing additional features of the modular tray.

FIG. 3 is a side view of the modular tray of FIG. 1.

FIG. 4 depicts a plan view of the tray of FIG. 1.

FIG. 5 depicts a plan view of an alternative tray, with a radial support configuration.

FIG. 6 is view of a tray assembly showing stacked modular trays and a fan.

FIG. 7 is a cut away view showing the modular tray cut along the line in 9-9 in FIG. 4.

FIG. 8 is a cut away view showing the modular tray cut along the line in 8-8 in FIG. 5.

FIG. 9 is a cut away view showing an alternative modular tray as cut along the line in 9-9 in FIG. 4.

### DETAILED DESCRIPTION OF THE INVENTION

The apparatus, kit and methods of the present invention provide a food simple and effective modular food dehydrator system, using an apparatus that can be easily assembled and disassembled of modular tray units and a readily available household fan. The modular units of the dehydrator apparatus have no moving parts, electrical systems or machinery that can be a source of failure.

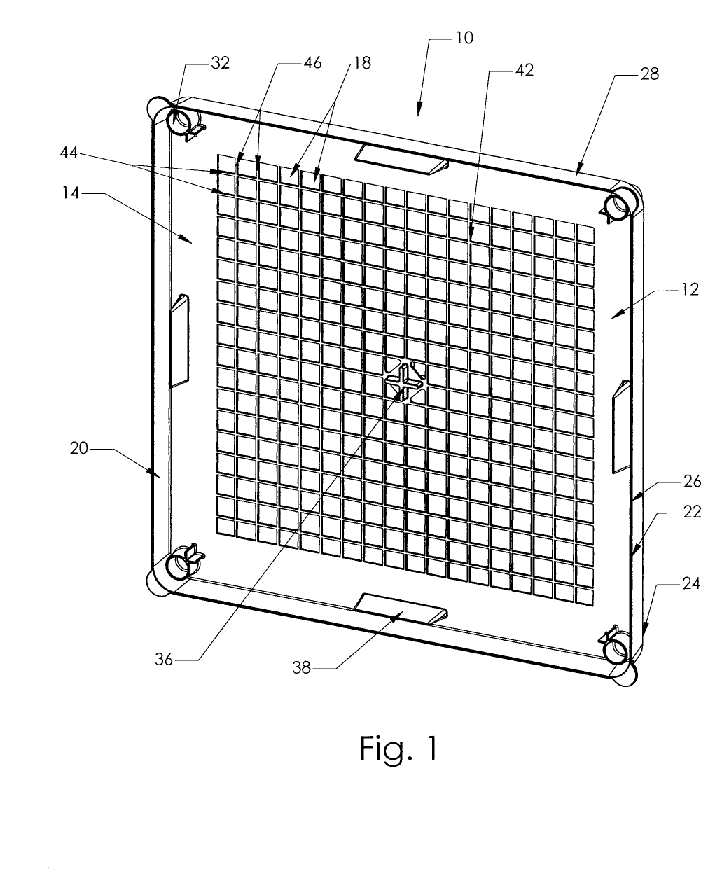

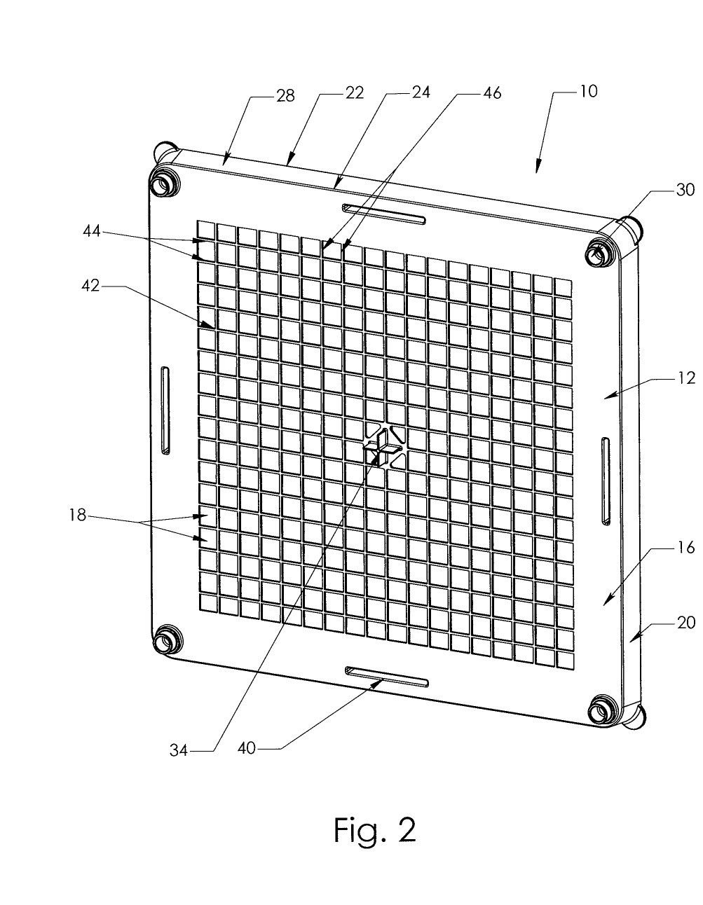

Looking to FIG. 1, which shows a perspective view of a modular food tray 10 of the apparatus from a lower positions, the apparatus includes a plurality of modular food trays 10, each such tray 10 comprising a generally horizontal drying rack 12 having an upper surface 14 and lower surface 16 (FIG. 2). The tray further has openings 18 for providing air passage generally vertically through the trays.

Each tray also has a wall 20 located at the periphery of the tray 10. The wall 20 extends generally vertically at the tray periphery, and has a top edge 22 and bottom edge 24, as well as an inner wall surface 26 and outer wall surface 28.

The trays also come with a plurality of legs 30 extending from the lower surface 16 of the drying rack 12 and beyond the wall bottom edge 24.

When two trays are stacked, the first or lower tray is rested against a flat support surface, such as a finished floor, and a second tray is nested onto the first tray. As best seen in FIG. 2, which provides a view of the tray of FIG. 1 from a top perspective, the upper surface 14 of the drying rack 12 can be provided with elevations 32 for nesting with the legs 30 of an adjacent tray 10 when two or more trays 10 are stacked together.

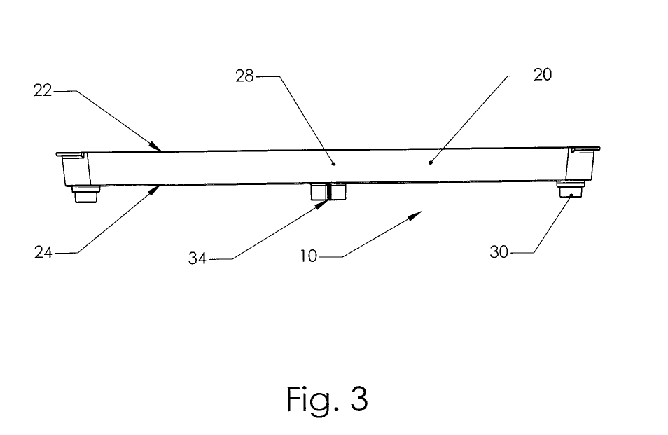

As seen in FIG. 3, where the tray 10 is large, it may be desirable to include a central support leg 34, which extends from the lower surface 16 of the drying rack 12. As seen in FIG. 1, a central elevation 36 along the upper surface 14 of the drying rack 12 can be provided for supporting the central support leg of an adjacenent nested tray.

For purposes of further alignment, guides 38 can ge provided in the upper surface 14 of the drying rack 12 (FIG. 1), and slots 40 in the lower surface 16 of the drying rack 12 (FIG. 2). These guides 38 and slots 40 provide good alignment of the walls 20 of nested trays 10.

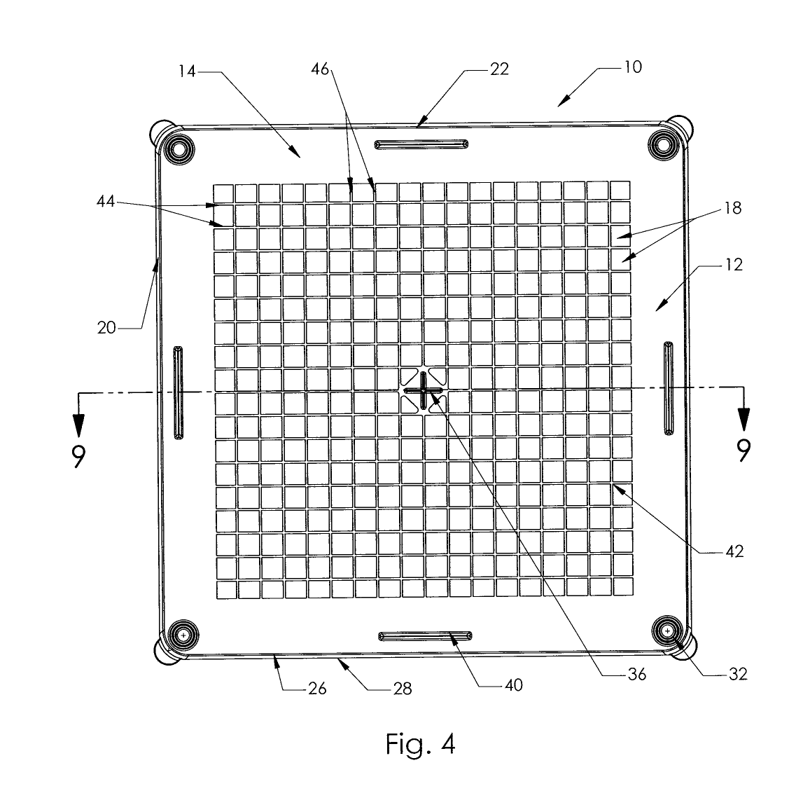

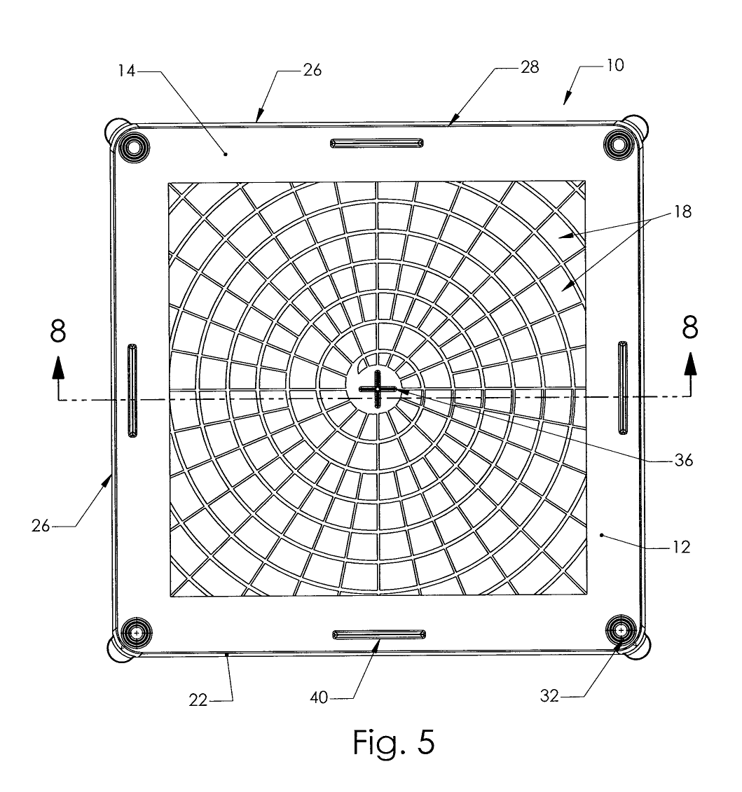

In reference to FIGS. 4 and 5, the drying rack 12 has open spaces 18 to allow circulation of air around food placed on the upper surface 14 of the drying rack 12.

The open spaces 18 can be manufactured through a number of mechanisms, all well known to the art. In FIG. 4, the open spaces are formed from support elements 42. In the tray 10 of the embodiment shown in FIG. 4, two perpendicular sets of elongated and parallel structures 44 and 46 provide the support elements 42, which form a square grid-like pattern at intersecting right angles. The support elements 42 form the solid, closed surface that makes contact with and supports food being placed on the drying rack 12, while also defining the open spaces 18.

In the embodiment shown in FIG. 5, the intersecting support elements 42 comprise respective radial 48 and circular 50 sets of structures.

The trays 10 are preferably dishwasher safe and immersible in water. They are most easily produced by injection molding, employing a plastic resin, such as polypropylene, polyethylene and polyester. The trays 10 may also be produced from recycled plastics, and the like. All such injection molding methods, materials, and apparatuses are well known to the art.

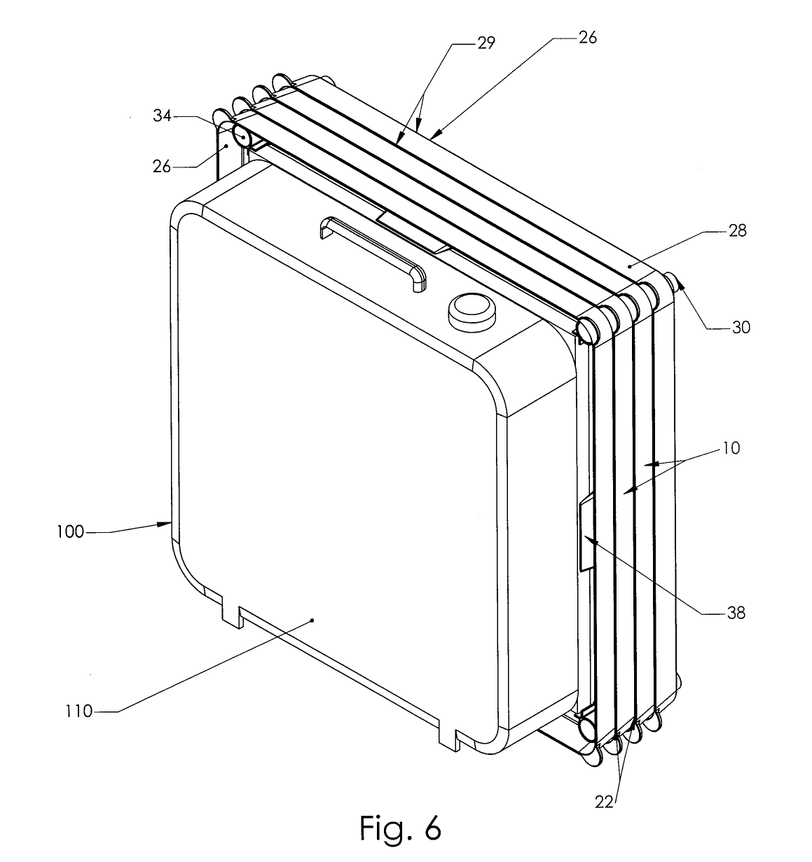

The present invention is also directed to a method of operating the food dehydrator apparatus. As seen in reference to FIG. 6, the method for dehydrating food using the apparatus comprises assembling a food dehydrator apparatus 100 from at least on food tray 10 and a household fan 110. In the drawing there are four nested trays 10, but in practice as many as 12 or 20 or more trays could be nested, depending on the strength of the fan 110 to push air through apparatus 100. The fan is nested and located within the top most tray. As also seen in reference to FIG. 6, the guides 38 may also be produced in the tray 10 to assist in positioning the fan 110 over the openings 18 in the drying rack 12.

The top wall edge 22 is sized to allow easy insertion by being larger in circumference than the outer dimensions of a standard household fan. The open spaces 18, however, are best covered by the fan 110 outer dimensions, in order to direct all of the circulating air into the interior of the apparatus 100.

When the apparatus 100 is assembled, the top edge 22 of the wall 20 of the first modular food tray and the bottom edge 24 of the wall of the second modular food tray form a close fit. This can be a tight friction fit. The tighter the tolerance, the better the apparatus 100 is at preventing air passage therebetween. As noted above, the guides 38 and slots 40 provide good alignment of the the top edge 22 of the wall 20 of a first modular food tray with the bottom edge 24 of the wall of a second modular food tray, when the first and second are nested.

When a first modular food tray 10 is set on a substantially flat support surface (not shown) with the legs 30 set on the support surface, a gap is formed between the wall bottom edge 24 and the support surface, the gap being set by the length of the legs 30. The gap essentially forms outlet vents at the base of the lower most unit, for venting the air circulated at the topmost tray by the fan 110.

The fan 110 can be a household fan, sometimes referred to as a box fan. Household fans come in various dimensions, but the most popular are fans of twenty inches square and ten inches square in size. Such household fans are well known to the consuming public, and are generally very inexpensive. Thus, in the event that there is a breakdown in the fan 110, which is the only and one aspect of the dehydrator apparatus 100 that has moveable or electric parts, it is a simple matter to replace. For these reasons, the trays 10 are preferably produced in sizes of ten inches and twenty inches square, or slightly larger as necessary to accommodate the fan.

As shown in FIG. 6, the modular food trays can be produced such that food will be secured between close upper and lower surfaces of respective drying racks 12, and the modular food trays 10 and fan 110 assembled or stacked horizontally in an apparatus that vents the air into the room rather than against a floor or other support surface.

Either before, during or after assembling the apparatus 100, food (not shown) is placed onto the upper surface 12 of at least one tray 10. The fan is then actuated, and room temperature air is circulated through the apparatus be the action of the fan.

While it is contemplated that the trays 10 can be provided in packages to consumers, the apparatus 100 may be provided as a food dehydrator kit comprising a fan 110 and a plurality of the described modular food trays 10.

Food suitable for dehydration is almost limitless. Commonly dehydrated foods include a number of fruits, such as apple, pear, pineapple, stone fruits, tropical fruits and various berries. Almost any vegetable can be dried. Finally, many varieties of meats, including game meets, are commonly dehydrated for storage and preservation. Preferably the fruit, vegetable, or meat be prepared to present a cut surface to the circulating air.

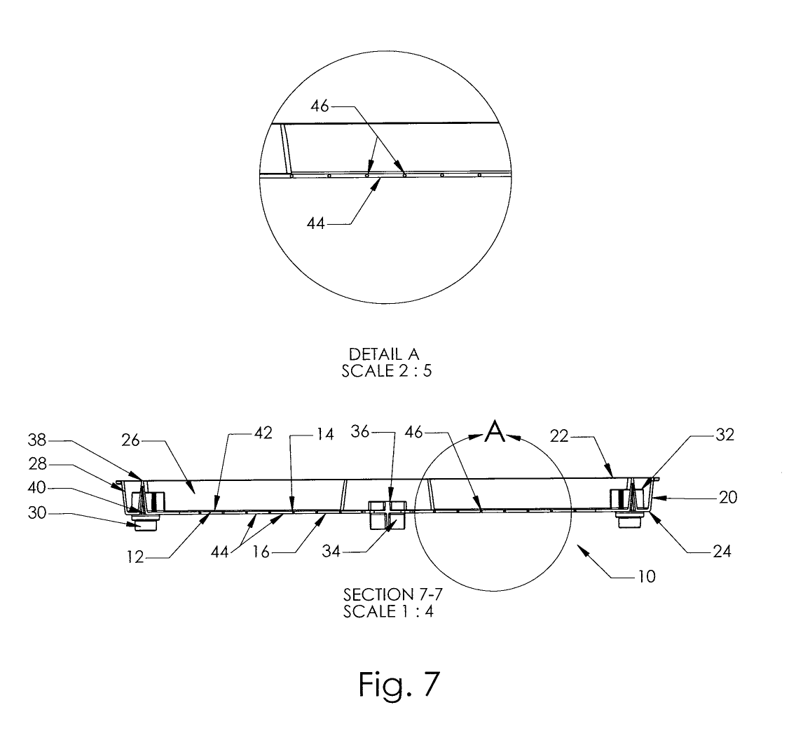

Since the amount of surface exposed to the air is a limitation on the dehydration process, the support elements 42 should be a small in diameter as is practicle. Looking to FIG. 7 the support elements 42 can be produced with a diamond configuration in cross section (see cutaway). In this embodiment, the diamond shape limits the amount of the support element 42 in actual contact with the food.

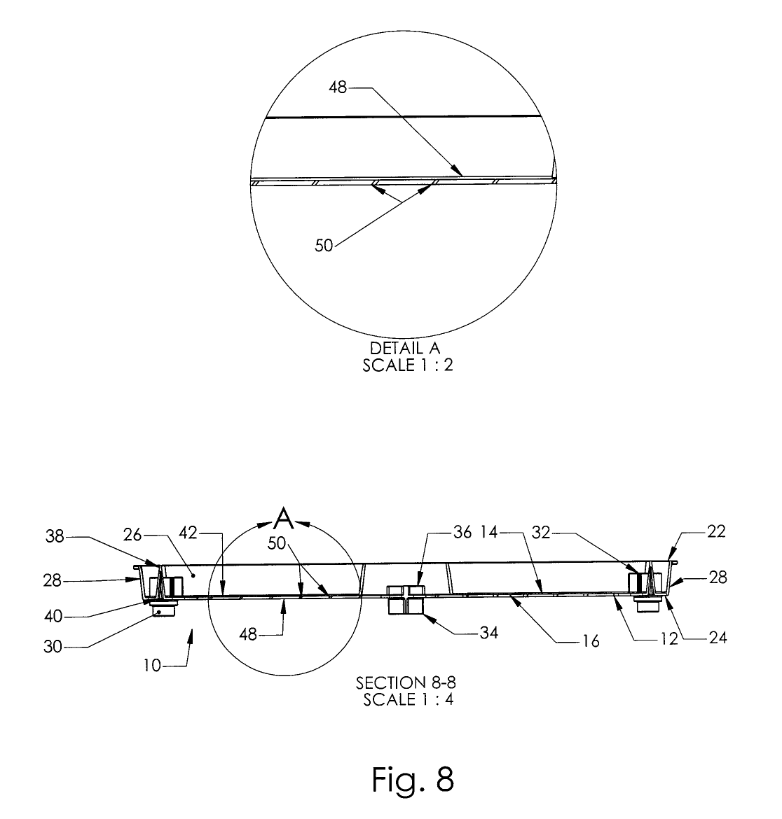

FIG. 8 and the cutaway show the support structure 42 of the embodiment shown in FIG. 5, it is seen how the support element, particularly the radial structure 48, can be used to further direct the air flow through the apparatus. In the cutaway it is seen that the radial structures 48 are biased to direct air flow circularly through an assembled apparatus, by each being non-vertical to some degree. A relatively small bias in each radial structure 48, over each tray 10 stacked in a multi-tray apparatus can create a significant redirection of air flow from the fan 110 through the apparatus 100.

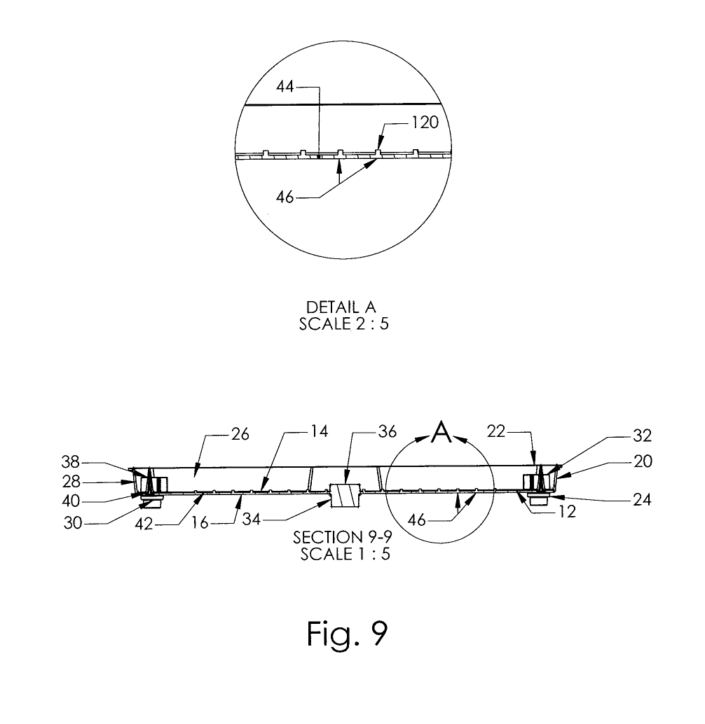

FIG. 9 discloses a further embodiment of the support structure 42 to reduce contact with the food surface. In this embodiment, the support structures 42 have intermittent raised portions 120 along their upper surface. These raised portions 120 create small points of contact to elevate the dehydrating food portions above the upper surface 14 of the drying rack 12, thereby increasing the surface area of food directly in contact with the circulating air.

The dehydrating performance of the food dehydrator has been assessed and shown to rapidly and efficiently produce dehydrated fruits, vegetables and meats.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

I claim:

1. A food dehydrator apparatus comprising:
a plurality of modular food trays, each tray comprising a generally horizontal drying rack having an upper and lower surface and openings providing for air passage extending generally vertically through the tray, a wall located at the periphery of said tray, said wall extending generally vertically at said periphery, and having a top and bottom edge, and an inner and outer wall surface, and a plurality of legs extending from the lower surface of said tray and below the lower edge of said wall,
wherein said trays are stackable, whereby when a first tray is adjacent a second tray, the top edge of the wall of said first tray and the bottom edge of the wall of said second tray form a close fit preventing air passage therebetween,
and wherein when said first modular food tray is position with said legs set on a substantially flat support surface, a gap is formed between said wall bottom edge and said support surface.

2. The apparatus of claim 1 wherein said drying rack comprises intersecting support elements forming open and closed spaces therein.

3. The apparatus of claim 1 wherein said support elements comprise two sets of parallel structures intersecting at right angles.

4. The apparatus of claim 3 wherein said support elements have a diamond configuration in cross section.

5. The apparatus of claim 3 wherein said support elements have intermittent raised portions along their upper surface.

6. The apparatus of claim 1 wherein said support elements comprise respective radial and circular sets of structures.

7. The apparatus of claim 6 wherein said radial support elements are biased to direct air flow circularly through an assembled apparatus.

8. The apparatus of claim 6 wherein the top edge of said wall is sized to accomodate the outer dimensions of a standard household fan.

9. The apparatus of claim 1 further comprising a central support leg extending from the lower surface of said tray.

10. A food dehydrator kit comprising:
a fan; and
a plurality of modular food trays, each tray comprising a generally horizontal drying rack having an upper and lower surface and openings providing for air passage extending generally vertically through the tray, a wall located at the periphery of said tray, said wall extending generally vertically at said periphery, and having a top and bottom edge, and an inner and outer wall surface, and a plurality of legs extending from the lower surface of said tray and below the lower edge of said wall,
wherein said trays are stackable, whereby when a first tray is adjacent a second tray, the top edge of the wall of said first tray and the bottom edge of the wall of said second tray form a close fit preventing air passage therebetween,
and wherein when said first modular food tray is position with said legs set on a substantially flat support surface, a gap is formed between said wall bottom edge and said support surface.

11. The kit of claim 10 wherein said drying rack comprises intersecting support elements forming open and closed spaces therein.

12. The kit of claim 10 wherein said support elements comprise two sets of parallel structures intersecting at right angles.

13. The kit of claim 10 wherein said support elements have a diamond configuration in cross section.

14. The kit of claim 10 wherein said support elements have intermittent raised portions along their upper surface.

15. The kit of claim 10 wherein said support elements comprise respective radial and circular sets of structures.

16. The kit of claim 15 wherein said radial support elements are biased to direct air flow circularly through an assembled apparatus.

17. The kit of claim 10 wherein the top edge of said top wall is sized to accomodate the outer dimensions of said fan.

18. The kit of claim 10 further comprising a central support leg extending from the lower surface of said tray.

19. The kit of claim 10 wherein said fan is a household fan.

20. The kit of claim 19 wherein said household fan is twenty inches square.

21. The kit of claim 19 wherein said household fan is ten inches square.

22. A method for dehydrating food comprising:
assembling a food dehydrator apparatus of claim 10, either before, during or after said assembly, placing food onto the upper surface of at least one modular food tray support structure; and
circulating room temperature air through said apparatus be actuating said fan.

23. The method of claim 22 wherein said drying rack comprises intersecting support elements forming open and closed spaces therein.

24. The method of claim 22 wherein said support elements comprise two sets of parallel structures intersecting at right angles.

25. The method of claim 24 wherein said support elements have a diamond configuration in cross section.

26. The method of claim 22 wherein said support elements comprise respective radial and circular sets of structures.

27. The method of claim 26 wherein said radial support elements are biased to direct air flow circularly through an assembled apparatus.

28. The method of claim 22 further comprising a central support leg extending from the lower surface of said tray.

29. The method of claim 22 wherein said fan is a household fan.

30. The method of claim 29 wherein said household fan is twenty inches square.

31. The method of claim 30 wherein said household fan is ten inches square.
